(19) United States
(12) Patent Application Publication
(10) Pub. No.: US 2008/0271965 A1
(43) Pub. Date: Nov. 6, 2008

(54) SPRING ELEMENTS FOR COMPOSITE BRAKE DISKS

(75) Inventors: Harald Reulein, Megesheim (DE); Thomas Freiermuth, Ulm (DE)

Correspondence Address: Novak Druce & Quigg LLP, 1300 I Street NW, Suite 1000 West Tower, Washington, DC, 20005, US

(73) Assignee: Audi AG, Ingolstadt (DE)

(21) Appl. No.: 12/045,279

(22) Filed: Mar. 10, 2008

(30) Foreign Application Priority Data
Mar. 10, 2007 (DE) 102007011743.6

(51) Int. Cl. F16D 65/12

(52) U.S. Cl. 188/218 XL

(57) ABSTRACT

The invention relates to spring elements having steps for composite brake disks which can also be made as lock washers, and the composite brake disks containing them with improved ease of braking.

### CROSS-REFERENCE TO RELATED APPLICATIONS

This application claims priority from German Application No. 10 2007 011 743.6 filed Mar. 10, 2007, hereby incorporated by reference in its entirety.

The invention relates to spring elements for composite brake disks.

### BACKGROUND OF THE INVENTION

Conventionally, carbon-ceramic brake disks are made in two parts, with a ceramic cylindrical ring-shaped friction ring being attached to a metallic chamber. The metallic chamber is attached for its part to a hub on the wheel shaft (wheel hub) using screw fittings. Combinations of screws and nuts are conventionally used to attach the friction ring to the chamber, the pressure surface between the screw head or the nut and the ceramic friction ring being enlarged by shims. Pretensioned shims (lock washers, disk springs) are also advantageously used.

Brake disks with a brake ring of gray cast iron material are also made in two parts, according to Patent Specification EP 0 718 521 B1 preferably both the brake disk ring and also the brake disk chamber being made of gray cast iron material.

This type of attachment with screws and nuts as well as disk springs is known for example from Patent Specification EP 0 718 521 B1.

Due to the mechanical properties of ceramic materials, it is necessary to make the support surface of the elastic shims such that the pressures which form in the attachment of the brake disk and in operation of brakes, and which act on the ceramic material, are kept sufficiently low so that damage to the ceramic materials cannot occur.

### SUMMARY OF THE INVENTION

The principal object of the present invention is achieved by providing an accurate spring band for the rotor of a brake disk assembly including an annular support member mountable on the hub of a vehicle axle and an annular friction member mounted on the support member, having at least one portion lying in a first plane mountable on said support member and at least one portion lying in a second plane spaced from such first plane engageable with the friction member.

The advantages achieved with this invention are ease of installation, in that fewer elastic parts, in one preferred embodiment only one elastic part per brake disk, need be used, effective axial damping of the composite brake disk, a reduction of the surface pressing in the support region, which is especially desirable in a brake disk chamber of aluminum or aluminum alloys, and radial play by elastic deformation of the lock washer in the radial direction. The amount of this allowable deformation can be easily set by suitable selection of spring properties and material thickness and the execution of steps of the spring elements.

### BRIEF DESCRIPTION OF THE DRAWINGS

FIG. 1 shows a perspective view of a composite brake disk with a connected brake disk chamber and brake disk ring and a lock washer, the lock washer being placed on the outside of the brake disk chamber,

FIG. 2 shows a section through a spring element in which the step is made without an offset, and

FIG. 3 shows a section through a spring element in which Z-shaped steps are made with offsets.

### DETAILED DESCRIPTION OF PREFERRED EMBODIMENTS OF THE INVENTION

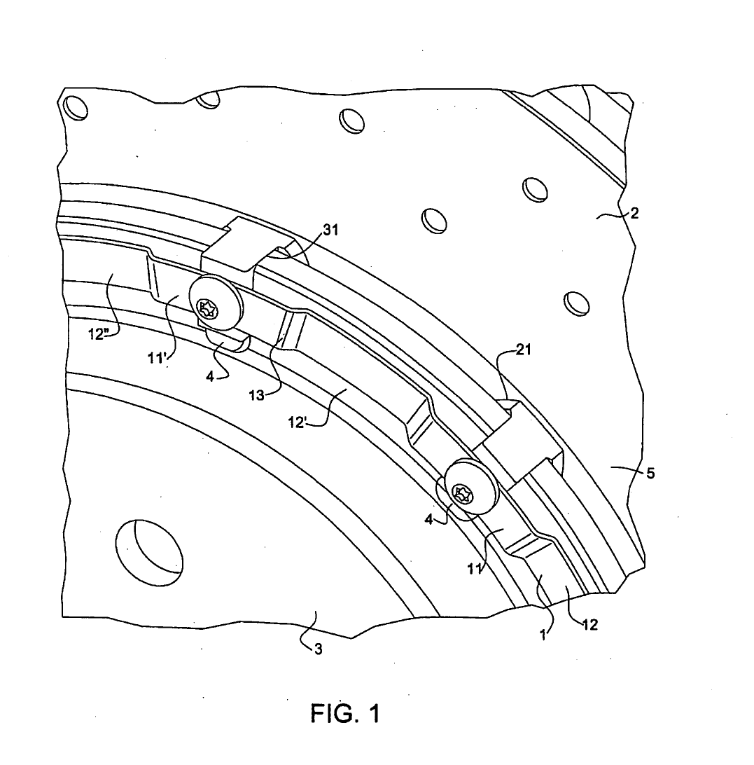

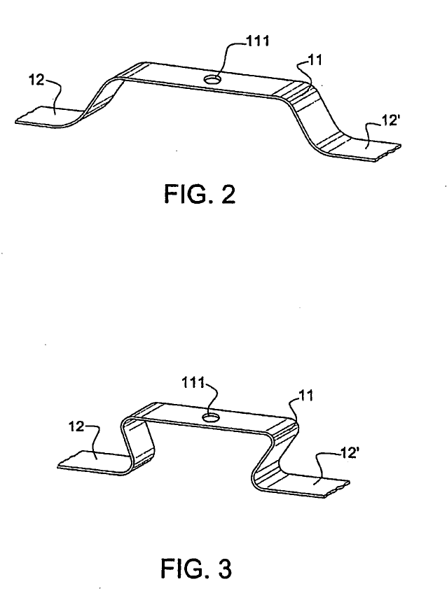

A composite brake disk 5 preferably comprises a brake disk ring 2 and a brake disk chamber 3 as well as a lock washer 1 which can be arranged either according to FIG. 1 on the outside of the brake disk chamber 3, that is, on the side facing away from the brake disk ring 2, or according to FIG. 2, between the brake disk chamber 3 and the brake disk ring 2, the brake disk ring and the brake disk chamber being interconnected by screws and by nuts which are not shown here. The sections 11 here each rest facing away from the brake disk ring, and the sections 12 rest facing the brake disk ring (according to FIG. 1) or rest directly on the brake disk ring.

Another preferred embodiment is to provide spring elements, each of which is held by at least two of the screws 4 which are used as fasteners and thus are also twist-proof.

According to the invention, the spring element 1 in alternation and in succession has at least four steps 13 such that at least two sections 11, 11′ each in the peripheral direction conform to an upper plane which is not shown and the respective sections 12, 12′, 12″ which are adjacent in the peripheral direction conform to the lower plane which is likewise not shown, the upper plane and the lower plane being parallel and having a vertical distance of 1 mm to 10 mm, and the sections 11 which conform to the upper plane having holes 111 for mounting screws 4, and the ratio of the sum of the arc lengths of the sections 11 conforming to the upper plane to the sum of the arc lengths of the sections 12 conforming to the lower plane being from 1:1 to 1:5.

The step between the sections 11 and 12 can be made either without an offset, as shown in FIG. 2, or with offsets in the form of a rounded “Z” as shown in FIG. 3, each of the two adjacent steps being made in mirror image to one another. This embodiment offers the advantage that under elastic stress no thrust is applied in the peripheral direction which leads to bulging in sections 11 and 12.

One preferred embodiment is that the spring element 1 forms a closed ring.

The composite brake disks according to the invention offer overall improved ease of braking, and the spring force can be set individually to the application (the respective vehicle, the desired sporty or comfort aspect) by a suitable choice of the material thickness, the step height, the execution of the step and the type of spring steel used for the spring element.

1. A spring element for attachment of a brake disk ring to a metallic brake disk chamber the spring element in alternation and in succession has at least four steps such that at least two sections each in the peripheral direction conform to an upper plane and the sections which are adjacent in the peripheral direction each conform to the lower plane, the upper plane and the lower plane being parallel and having a vertical distance of 1 mm to 10 mm, that the sections which conform to the upper plane have holes for mounting screws, and that the ratio of the sum of the arc lengths of the sections conforming to the upper plane to the sum of the arc lengths of the sections conforming to the lower plane is from 1:1 to 1:5.

2. The spring element according to claim 1 wherein the material of the spring element is steel.

3. The spring element according to claim 1 wherein the steps have a Z-shaped profile, each of the two adjacent steps being made in mirror image to one another.

4. The spring element according to claim 1 wherein the spring element forms a closed ring.

5. A composite brake disk comprising a brake disk ring and a metallic brake disk chamber, as well as at least one spring element according to claim 1, wherein the spring element with the sections which conform to the lower plane rests on the metallic brake disk chamber and the mounting screws are routed through holes, through openings in the metallic brake disk chamber and through openings in the brake disk ring and are fixed on the side of the brake disk ring facing away from the screw head with a nut or a fastening part such that a force is applied to the section of the spring element in the direction to the brake disk ring.

6. The composite brake disk according to claim 5 wherein at least some of the sections are attached to the brake disk chamber.

7. The composite brake disk according to claim 6 wherein the sections are attached to the brake disk chamber by at least one of cementing or screwing.

8. The composite brake disk according to claim 5 wherein the spring element forms a closed ring.

9. The composite brake disk comprising a brake disk ring and a metallic brake disk chamber, as well as at least one spring element according to claim 1 wherein the spring element with the sections which conform to the lower plane rests on the metallic brake disk chamber and the mounting screws are routed through openings in the metallic brake disk chamber and through openings in the brake disk ring and are fixed on the side of the brake disk ring facing away from the screw head with a nut or a fastening part such that a force is applied to the section of the spring element in the direction to the brake disk ring.

10. The composite brake disk according to claim 9 wherein the spring element forms a closed ring.

11. A spring band for the rotor of a brake disk assembly of a vehicle including an annular support member mountable on the hub of an axle and an annular friction member mounted on said support member having at least one portion lying in a first plane mountable on said support member and at least one portion lying in a second plane spaced from said first plane engageable with said friction member when said first portion is mountable on said support member.

12. A spring according to claim 10 including a third portion interconnecting each first and second mentioned portions configured to permit displacement between said first and second mentioned portions.
